(19) United States
(12) Patent Application Publication
(10) Pub. No.: US 2014/0269501 A1
(43) Pub. Date: Sep. 18, 2014

(54) SYSTEMS AND METHODS FOR TRANSITIONING A TELEPHONY COMMUNICATION BETWEEN CONNECTION PATHS TO PRESERVE COMMUNICATION QUALITY

(71) Applicant: VONAGE NETWORK, LLC, Holmdel, NJ (US)

(72) Inventors: GUY FIGHEL, RED BANK, NJ (US); KA-YUI KEVIN MA, NORTH BRUNSWICK, NJ (US)

(73) Assignee: VONAGE NETWORK, LLC, HOLMDEL, NJ (US)

(21) Appl. No.: 13/838,160

(22) Filed: Mar. 15, 2013

(51) Int. Cl. H04W 76/04

(52) U.S. Cl. CPC H04W 76/04
USPC 370/328

(57) ABSTRACT

An IP telephony communication being conducted by a user telephony device is transitioned from an IP based communications path to a cellular based voice or video communications path if a quality of the telephony communication falls below a threshold level. The user telephony device and/or elements of an IP telephony system handling the call could detect when the quality is below the threshold level. The communication might also be transitioned to a cellular based voice or video communications channel if the strength of a wireless connection between the user telephony device and a wireless access point providing access to a data network falls below a threshold level.

### BACKGROUND OF THE INVENTION

The invention is related to Internet Protocol (IP) telephony systems. More specifically, the invention is related to telephony devices and methods of routing telephony communications via an IP telephony system

Many telephony devices in use today are capable of conducting a telephony communication via either an IP communications path or a cellular based voice or video communication path. To accomplish this, the IP telephony devices include both a wireless data transceiver capable of communicating data packets over a data network, and a wireless transceiver capable of communicating with elements of a cellular telephony system.

It is typically less costly to conduct a telephony communication over an IP based communications path, as opposed to a cellular based voice or video communications path. However, because of varying data network conditions, the quality of a telephony communication traversing an IP based communications path can deteriorate at unpredictable times. Variations in data packet delivery statistics such as packet loss, latency, jitter and others can have a large influence on the quality of a telephony communication traversing an IP based communication path. If data packet delivery is slow or unpredictable, or if there is a significant loss of data packets, the call quality typically deteriorates.

In addition, a telephony device will often establish an IP based communications path by forming a connection to a data network via a wireless access point, such as wireless router. If the telephony device moves away from the wireless access point, the signal strength of the connection between the IP telephony device and the wireless access point can decline to the point that the data packet delivery statistics begin to decline. Thus, the strength of the wireless connection between the telephony device and the data access point can also influence call quality.

A telephony device can also establish an IP based communication path via a data link provided by a cellular telephony service provider. Here again, the strength of the wireless connection between the telephony device and elements of the cellular telephony system can also influence the data packet delivery statistics, and thus the quality of a telephony communication which is traversing an IP based communications path through a cellular telephony system.

Because many devices capable of conducting a telephony communication via an IP based communications path are also capable of communicating via a cellular based voice or video communications path, it would desirable to transition an ongoing communication from an IP based communications path to a cellular based voice or video communications path if the quality of the telephony communication has began to deteriorate for any of the reasons discussed above.

### BRIEF DESCRIPTION OF THE DRAWINGS

FIG. 1 is a diagram of a communications environment including various elements which are associated with an Internet protocol (IP) telephony system operating in accordance with one embodiment of the invention;

FIG. 2 is a diagram of various elements of a processor that forms part of a telephony device or an IP telephony system in accordance with one embodiment of the invention;

FIG. 3 is a diagram illustrating selected elements of an IP telephony system in accordance with one embodiment of the invention;

FIG. 4 is a diagram illustrating selected elements of a telephony device in accordance with one embodiment of the invention;

FIG. 5 is a diagram illustrating the connection paths traversed by telephony communications between various telephony devices in accordance with one embodiment of the invention;

FIG. 6 is a flow diagram illustrating steps of a first method for transitioning a telephony communication between different communications paths to preserve call quality in accordance with one embodiment of the invention; and

FIG. 7 is a flow diagram of a second method for transitioning a telephony communication between different communications paths to preserve call quality in accordance with one embodiment of the invention.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

In the following description, the terms VOIP system, VOIP telephony system, IP system and IP telephony system are all intended to refer to a system that connects callers and that delivers data, text or video communications using Internet protocol data communications.

As illustrated in FIG. 1, a communications environment 100 is provided to facilitate IP based communications. A first IP telephony system 120 enables connection of telephone calls between its own customers and other parties via data communications that pass over a data network. The data network is commonly the Internet 110, however, private data networks may form all or a portion of the data communication path. The IP telephony system 120 is connected to the Internet 110. In addition, the IP telephony system 120 is connected to both a first publicly switched telephone network (PSTN) 130 located in a first country, and a second PSTN 140 located in a second country via one or more gateways 122.

The gateway 122 allows users and devices that are connected to the first and second PSTNs 130, 140 to connect with users and devices that are reachable through the first IP telephony system 120, and vice versa. In some instances, the gateway 122 would be a part of the first IP telephony system 120. In other instances, the gateway 122 could be maintained by a third party.

Customers of the first IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a cellular telephone system to access the Internet 110.

Alternatively, a customer could utilize an analog telephone 102a which is connected to the Internet 110 via a terminal adapter 104. The terminal adapter 104 converts analog signals from the telephone 102a into data signals that pass over the Internet 110, and vice versa. Also, as illustrated in FIG. 1, multiple analog telephones 102a and 102b could all be coupled to the same terminal adaptor 104. Analog telephone devices include, but are not limited to, standard telephones and document imaging devices such as facsimile machines. A configuration using a terminal adapter 104 is common where all of the analog telephones 102a, 102b are located in a residence or business, and all of the telephones are connected to the same terminal adapter. With this configuration, all of the analog telephones 102a, 102b share the same telephone number assigned to the terminal adaptor 104. Other configurations are also possible where multiple communication lines (e.g., a second telephone number) are provisioned by the IP telephony system 120.

In addition, a customer could utilize a soft-phone client running on a computer 106 to place and receive IP based telephone calls, and to access other IP telephony systems. In some instances, the soft-phone client could be assigned its own telephone number. In other instances, the soft-phone client could be associated with a telephone number that is also assigned to an IP telephone 108, or to a terminal adaptor 104 that is connected to one or more analog telephones 102a, 102b.

A third party using the first analog telephone 132 which is connected to the first PSTN 130 may call a customer of the IP telephony system 120. In this instance, the call is initially connected from the first analog telephone 132 to the first PSTN 130, and then from the first PSTN 130, through the gateway 122 to the first IP telephony system 120. The first IP telephony system 120 then routes the call to the customer's IP telephony device. A third party using the first cellular telephone 134 could also place a call to an IP telephony system customer, and the connection would be established in a similar manner, although the first link would involve communications between the first cellular telephone 134 and a cellular telephone network. For purposes of this explanation, the cellular telephone network is considered part of the first PSTN 130.

In addition, mobile computing devices which include cellular telephony capabilities could also be used to place telephone calls to customers of the IP telephony system. A first mobile computing device 136, as illustrated in FIG. 1, might connect to the first PSTN 130 using its cellular telephone capabilities. However, such devices might also have the ability to connect wirelessly via some other means. For example, the mobile computing device 136 might communicate with a wireless data router to connect the first mobile computing device 136 directly to a data network, such as the Internet 110. In this instance, communications between the first mobile computing device 136 and other parties could be entirely carried by data communications which pass from the first mobile computing device 136 directly to a data network 110. Of course, alternate embodiments could utilize any other form of wired or wireless communications path to enable communications.

Users of the first IP telephony system 120 are able to access the service from virtually any location where they can connect to the Internet 110. Thus, a customer could register with an IP telephony system located in the U.S., and that customer could then use an IP telephone 108 located in a country outside the U.S. to access the services. Likewise, the customer could also utilize a computer outside the U.S. that is running a soft-phone client to access the first IP telephony system 120. Further, in some instances a user could place a telephone call with the first analog telephone 132 or first cellular telephone 134 that is routed through the first PSTN 130 to the first IP telephony system 120 via the gateway 122. This would typically be accomplished by the user calling a local telephone number that is routed to the first IP telephony system 120 via the gateway 122. Once connected to the first IP telephony system 120, the user may then place an outgoing long distance call to anywhere in the world using the first IP telephony system's network. Thus, the user is able place a long distance call using lower cost IP telephony service provided by the first IP telephony system 120, rather than a higher cost service provided by the first PSTN 130.

FIG. 1 also illustrates that a second IP telephony system 170 located in the second country may interact with the first IP telephony system 120 in the first country via the Internet 110. For example, customers of the second IP telephony system 170 may place calls to customers of the first IP telephony system 120. In that instance, assets of the second IP telephony system 170 interact with assets of the first IP telephony system 120 to setup and carry the telephone call. Conversely, customers of the first IP telephony system 120 can place calls to customers of the second IP telephony system 170. Because the IP telephony systems interact with each other over a data network, a first customer of the first IP telephony system 120 that is located in the first country can place a call to a second customer of the second IP telephony system 170 in the second country for a considerably lower cost than if a similar call were established through the first country PSTN 130 and second country PSTN 140.

The second IP telephony system could also interact with customers of a second PSTN 140 via a gateway 172. The second PSTN 140 may be connected to a second analog telephone 174, a second cellular telephone 176 and a second mobile computing device 178.

In the following description, we will assume that the first IP telephony system 120, the first PSTN 130, the IP telephone 108, the VOIP adaptor 104, the first analog telephone 132, the first cellular telephone 134 and the first mobile computing device 136 are all located in a first country. Also, the second IP telephony system 170, the second PSTN 140, the second analog telephone 174, the second cellular telephone 176 and the second mobile computing device 178 are all located in a second country.

FIG. 2 illustrates elements of a computer processor 250 that can be used as part of the first or second IP telephony systems 120, 170, or as part of an IP telephony device, to accomplish various functions. Each of the IP telephony systems 120, 170, or an IP telephony device, could include multiple processors 250, along with their operating components and programming, each carrying out a specific or dedicated function.

The processor 250 shown in FIG. 2 may be one of any form of a general purpose computer processor used in accessing an IP-based network, such as a corporate intranet, the Internet or the like. The processor 250 comprises a central processing unit (CPU) 252, a memory 254, and support circuits 256 for the CPU 252. The processor 250 also includes provisions 258/260 for connecting the processor 250 to customer equipment, to service provider equipment, to IP network or gateways, as well as possibly one or more input/output devices (not shown) for accessing the processor and/or performing ancillary or administrative functions related thereto. The provisions 258/260 are shown as separate bus structures in FIG. 2; however, they may alternately be a single bus structure without degrading or otherwise changing the intended operability of the processor 250.

The memory 254 is coupled to the CPU 252. The memory 254, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 256 are coupled to the CPU 252 for supporting the processor in a conventional manner. These circuits include cache, power supplies, clock circuits, input/output circuitry and subsystems, and the like.

A software routine 262, when executed by the CPU 252, causes the processor 250 to perform processes of the disclosed embodiments, and is generally stored in the memory 254. The software routine 262 may also be stored and/or executed by a second CPU (not shown) that is remotely located from the hardware being controlled by the CPU 252. Also, the software routines could also be stored remotely from the CPU. For example, the software could be resident on servers and memory devices that are located remotely from the CPU, but which are accessible to the CPU via a data network connection.

The software routine 262, when executed by the CPU 252, transforms the general purpose computer into a specific purpose computer that performs one or more functions of an IP telephony system 120/170 or an IP telephony device. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 262 of the disclosed embodiments is capable of being executed on any computer operating system, and is capable of being performed using any CPU architecture.

In the following description, references will be made to an “IP telephony device.” This term is used to refer to any type of device which is capable of interacting with an IP telephony system to complete a telephone call. An IP telephony device could be an IP telephone, a computer running IP telephony software, a terminal adapter which is connected to an analog telephone, or some other type of device capable of communicating via data packets. An IP telephony device could also be a cellular telephone or a portable or tablet computing device that runs a software client that enables the device to act as an IP telephone. Thus, a single device might be capable of operating as both a cellular telephone and an IP telephony device.

Moreover, certain devices that are not traditionally used as telephony devices may act as telephony devices once they are configured with appropriate client software. Thus, some devices that would not normally be considered telephony devices may become telephony devices or IP telephony devices once they are running appropriate software. One example would be a desktop or a laptop computer that is running software that can interact with an IP telephony system over a data network to conduct telephone calls. Another example would be a portable computing device, such as an Apple iPod Touch™, which includes a speaker and a microphone. A software application loaded onto an Apple iPod Touch™ can be run so that the Apple iPod Touch™ can interact with an IP telephony system to conduct a telephone call.

The following description will also refer to telephony communications and telephony activity. These terms are intended to encompass all types of telephony communications, regardless of whether all or a portion of the communications are carried in an analog or digital format. Telephony communications could include audio or video telephone calls, facsimile transmissions, text messages, SMS messages, MMS messages, video messages, and all other types of telephony and data communications sent by or received by a user. These terms are also intended to encompass data communications that are conveyed through a PSTN or VOIP telephony system. In other words, these terms are intended to encompass any communications whatsoever, in any format, which traverse all or a portion of a communications network or telephony network.

In systems and methods embodying the invention, the quality of a communication between a user's telephony device and an IP telephony system that is traversing an IP based communications path is monitored. This can include monitoring both the quality of the data packet transmissions between the user's telephony device and the IP telephony system, and a strength of a wireless connection that the user's telephony device has established with either a wireless access point or an element of a cellular telephony system. If the quality of the communication deteriorates below a threshold level due to either or both of these factors, the media of the communication is transitioned from the IP based communications path to a cellular based voice or video communications path.

FIG. 3 illustrates selected elements of an IP telephony system according to one embodiment of the invention. As shown in FIG. 3, the IP telephony system 300 includes a call setup unit 302. The call setup unit 302 includes an IP communications path setup unit 304, a cellular communications path unit 306, and a communications path transition unit 308. The IP telephony system 300 also includes a quality monitoring unit 310 which is responsible for monitoring the quality of telephony communications which are being conducted by user telephony devices. The IP telephony system also includes a CDR unit 312 which receives call detail records relating to telephony communications passing through the IP telephony system. The IP telephony system 300 further includes a billing unit 314 which utilizes information from the CDR unit 312 in order to bill for the communications handled by the IP telephony system 300. The way in which these elements of the IP telephony system operate to perform methods embodying the invention will be described in detail below.

FIG. 4 illustrates a user telephony device 400 in accordance with one embodiment of the invention. The telephony device 400 includes a wireless data transceiver 402 which is capable of communicating data packets with a wireless access point that provides the telephony device 400 with access to a data network. The wireless data transceiver 402 would send and receive data packets that are used to establish and conduct IP based telephony communications.

The telephony device 400 also includes a wireless cellular transceiver 404 which is capable of communicating with elements of a cellular telephony system. The wireless cellular transceiver could communicate in various different communication protocols with elements of the cellular telephony system in order to conduct voice or video telephony communications. The wireless cellular transceiver 404 may also be capable of communicating data packets through a data channel of the cellular telephony system that provides access to a data network, such as the Internet. This would allow the telephony device to conduct an IP based telephony communication through the data channel provided by the cellular telephony system.

The telephony device 400 also includes IP telephony client software 410. The IP telephony client software 410 is used to set up and conduct IP telephony communications with an IP telephony system, such as the one illustrated in FIG. 3. The IP telephony client software 410 includes an IP communications path setup unit 412 which is capable of establishing an IP based communications path with an IP telephony system utilizing the wireless data transceiver 402. The IP telephony client software 410 also includes a cellular communications path set up unit 414 which is capable of establishing a cellular based voice or video communications path utilizing the wireless cellular transceiver 404.

The IP telephony client software 410 also includes a quality monitoring unit 416. The quality monitoring unit 416 monitors data packet delivery statistics, such as packet loss, latency, and jitter, as a way of monitoring the quality of an IP telephony communication. The quality monitoring unit 416 may also measure or detect the quality of IP telephony communications in various other ways. Further, the quality monitoring unit 416 may directly interact with the user of the telephony device 400 to receive input regarding the quality of IP telephony communications.

The IP telephony client software 410 also includes a wireless connection monitoring unit 418. The wireless connection monitoring unit 418 monitors a strength of a wireless connection established by the wireless data transceiver 402 to a wireless access point which provides access to a data network. The wireless connection monitoring unit 418 may also monitor a strength of a wireless connection established between the wireless cellular transceiver 404 and one or more elements of a cellular telephony system. The wireless connection monitoring unit 418 could utilize native elements of the telephony device 400 in order to determine the strength of those wireless connections.

The IP telephony client software 410 further includes a communications path transition unit 420. The communications path transition unit 420 is responsible for transitioning an ongoing telephony communication between an IP based communications path and a cellular based voice or video communications path.

The way in which the above described elements of the telephony device 400 operate in order to preserve the quality of an ongoing communication will be described in detail below.

FIG. 5 presents a diagram which can be used to help illustrate how systems and methods embodying the invention act to preserve the quality of a telephony communication. FIG. 5 illustrates that a first mobile telephony device 502 is capable of establishing a first IP based communications path P1 with an IP telephony system 520 via a first wireless access point 504 and the Internet 506. The first mobile telephony device 502 is also capable of establishing an alternate IP based communications path P7 with the IP telephony system 520 via a second wireless access point 505 and the Internet 506. The first mobile telephony device 502 is further capable of establishing a second cellular based voice or video communications path P2 with the IP telephony system 520 via a first cellular telephony system 508. FIG. 5 also illustrates that a second mobile telephony device 510 is capable of establishing a third IP based communications path P3 with the IP telephony system 520 via a second wireless access point 512 and the Internet 506. The second mobile telephony device is also capable of establishing a fourth cellular based voice or video communications path P4 with the IP telephony system 520 via the first cellular telephony system 508. All of the aforementioned elements are located in first country.

FIG. 5 further illustrates that a third mobile telephony device 540 is capable of establishing a fifth IP based communications path P5 with the IP telephony system 520 via a third wireless access point 542 and the Internet 506. Alternatively, the third mobile telephony device 540 is capable of establishing a sixth cellular based voice or video communications path P6 with the IP telephony system 520 via a second cellular telephony system 530. The third mobile telephony device 540, the third wireless access point 542 and the second cellular telephony system 530 are all located in a second country.

A first method for transitioning an ongoing telephony communication from an IP based communications path to a cellular based voice or video communications path in order to preserve call quality will now be described with reference to elements of the IP telephony system 300 shown in FIG. 3, the elements of a telephony device shown in FIG. 4, and with reference to FIGS. 5 and 6.

We will first assume that the first mobile telephony device 502 has established a first IP based communications path P1 to the IP telephony system 520 via the first wireless access point 504 and the Internet 506. The first IP based communications path P1 is used to conduct an IP telephony communication with the second mobile telephony device 510 over a third IP based communications path P3 which has been established between the second mobile telephony device 510 and the IP telephony system 520 via the second wireless access point 512 and the Internet 506. A method 600 illustrated in FIG. 6 is then performed by elements of the IP telephony system 520 in order to preserve the quality of the telephony communication.

The method 600 begins and proceeds to step S602 where the quality of the telephony communication traversing the first IP based communications path P1 and/or traversing the second IP based communications path P3 is determined. The determination would be made by a quality monitoring unit 310 of the IP telephony system, as illustrated in FIG. 3. As explained above, this could include determining various data packets delivery statistics for communications passing back and forth between the first mobile telephony device 502 and the IP telephony system 520 via the first IP based communications path P1. This could also include monitoring or determining data packet delivery statistics for communications between the second mobile telephony device 510 and the IP telephony system 520 via the second IP based communications path P3. In alternate embodiments, the quality monitoring unit 310 of the IP telephony system could calculate or determine the quality of the communications using other means. Moreover, the quality monitoring unit 310 could receive input from a user of the first mobile telephony device 502 or a user of the second mobile telephony device 510 which is indicative of the current communication quality.

Next, in step S604, a determination is made as to whether the quality of the communication is below a threshold value. The determination made in step S604 could be a determination about the quality of the communication passing through the leg extending between the first mobile telephony device 502 and the IP telephony system 520. The determination made in step S604 could alternatively be about the leg of the communication extending between the second mobile telephony device 510 and the IP telephony system 520. In yet other embodiments, the determination made in step S604 could include the quality of all legs of the communication extending between the first mobile telephony device 502 and the second mobile telephony device 510.

If the determination made in step S604 indicates that the quality is not below a threshold value, meaning the call quality is sufficient, then the method proceeds to step S606. In step S606 a delay period is allowed to expire. The method then proceeds back to step S602, where another determination of the quality of the communication is made. The method will proceed to loop through steps S602, S604 and S606 for the duration of the telephony communication provided the call quality remains above the threshold. The method would ultimately end when one of the parties terminates the communication.

Alternatively, if the determination made in step S604 indicates that the quality of a communication is below the threshold, the method proceeds to step S608. In step S608, a cellular communications path setup unit 306 of the IP telephony system establishes a cellular based voice or video communications path between the IP telephony system 520 and one or both of the first mobile telephony device 502 and the second mobile telephony device 510. For example, if the determination made in steps S602 and S604 indicate that the quality of the communication has gone below the threshold value for the leg of the communication extending between the first mobile telephony device 502 and the IP telephony system 520, then step S608 would involve establishing a cellular based voice or video communications path P2 between the first mobile telephony device 502 and the IP telephony system 520.

At this point, two communications paths P1 and P2 are established between the first mobile telephony device 502 and the IP telephony system 520. The communication would continue to traverse the first IP based communications path P1 between the first mobile telephony device 502 and the IP telephony system 520 while the cellular based voice or video communications path P2 is being established through the first cellular telephony system 508. Once the cellular based voice or video communications path P2 has been established, in step S610 a communications path transition unit 308 of the IP telephony system transitions the communication from the IP based communications path P1 to the cellular based voice or video communications path P2.

In some embodiments, step S608 could involve the IP telephony system 520 placing an outgoing telephone call to the first mobile telephony device 502 via the first cellular telephony system 508. Step S610 could then involve conferencing the cellular call to the communication that is already ongoing through the first IP based communications path P1. Once the cellular based call traversing the second cellular based communications path P2 has been conferenced into the original call, the leg of the call traversing the first IP based communications path P1 between the first mobile telephony device 502 and the IP telephony system 520 is terminated. In alternate embodiments, the transition of a communication from an IP based communications path to a cellular based voice or video communications path could be accomplished in a different fashion. Once the call has been transitioned to the cellular based voice or video communications path, the method ends.

In alternate embodiments of the invention, rather than immediately transitioning the communication to a cellular based communication path, step S608 could involve other steps which are taken to improve call quality before a decision is reached to transition the communication to a cellular based communication path. For example, when the quality of a leg of the communication is determined to be poor, a first step to rectify the problem could involve switching to a different CODEC, applying noise canceling techniques or other similar measures. Basically, one would attempt to improve call quality without changing the communication path.

If these initial measures do not improve call quality be a sufficient amount, the next step could be to try using a different IP based communication path. For example, an alternate IP based communication path P7 could be established between the first mobile telephony device 502 and the IP telephony system 520 via a second wireless access point 505. If a quality IP communication path can be established in this fashion, the communication could be transition to the alternate IP communication path P7. This would allow the communication to continue to use an IP based path, as opposed to a cellular based communication path, which is likely to be more costly.

Moreover, an alternate IP based communication path might be established through the first cellular telephony system 508 using a data channel, such as a 3G or 4G data channel. Thus, the communication may continue to use an IP based communication path, even through that path makes use of the first cellular telephony system 508.

If all the IP based communication paths which are available fail to provide sufficient quality, then the ultimate step is to setup a cellular voice or video communications path through the first cellular telephony system 508.

In the explanation provided above, only the leg of the call between the first mobile telephony device 502 and the IP telephony system 520 is transitioned from an IP based communications path to a cellular based voice or video communications path. In alternate embodiments, the leg of the call between the second mobile telephony device 510 and the IP telephony system 520 can also be transitioned at the same time, or shortly thereafter.

In yet other embodiments, only the leg of the call between the second mobile telephony device 510 and the IP telephony system 520 is transitioned from an IP based communications path to a cellular based voice or video communications path. Moreover, if a communication between the first mobile telephony device 502 and the second mobile telephony device 510 originally traverses IP based communication paths to and from the IP telephony system 520, then when a first leg of that communication is transitioned to a cellular based voice or video communications path, the method could include continuing to monitor the quality of the leg of the communication passing through an IP based communications path. If the remaining IP based communications path begins to experience quality problems, then that leg of the call could also be transitioned to a cellular based voice or video communications path.

FIG. 5 also illustrates that a telephony communication could be established between a first mobile telephony device 502 in a first country and a third mobile telephony device 540 in a second country. The leg of the communication passing between the IP telephony system 520 and the third mobile telephony device 540 could initially traverse a fifth IP based communications path P5 which passes through the Internet 506 and a third wireless access point 542. Alternatively, the leg of the communication between the IP telephony system 520 and the third mobile telephony device 540 could traverse a sixth cellular based voice or video communications path P6 which involves the second cellular telephony system 530.

The same basic methods of monitoring call quality and transitioning the call from an IP based communications path to a cellular based voice or video communications path would still be utilized, as described above. However, when the telephony communication is passing to a third mobile telephony device 540 in a second country, and it is necessary to transition the leg of the call between the IP telephony system 520 and the third mobile telephony device 540 from a fifth IP based communications path P5 to a sixth cellular based voice or video communications path P6, it would be desirable to establish that cellular based communications path at the lowest possible cost. If the IP telephony system 520 is located in the first country, and the IP telephony system 520 simply places an outgoing cellular telephone call to the third mobile telephony device 540, it would be necessary to pay international long distance rates to establishing the cellular based communications path, which would be undesirable.

For this reason, whenever possible, it is instead desirable for the IP telephony system 520 to forward the communication via an IP based communication path P7 to a gateway 535 located within the second country. The gateway 535 located within the second country then places a call to the third mobile telephony device 540 via the second cellular telephony system 530. As a result, only local cellular termination rates need be charged by the second cellular telephony system 530 in order to establish the cellular based voice or video communications path P6. The gateway 535 could be an element which is owned and/or controlled by the IP telephony system 520, or the gateway 535 could be owned and/or controlled by another entity, and the IP telephony system 520 could simply pay to use the gateway 535 in order to set up cellular telephony communications within the second country.

The above described methods, which are illustrated in FIG. 6, assumed that a determination of the quality of a communication is performed by a quality monitoring unit 310 of an IP telephony system as illustrated in FIG. 3. However, step S602 in FIG. 6 could also be performed by a quality monitoring unit 416 of one of the telephony devices involved in the communication. The quality monitoring unit 416 could then report the determined quality to the IP telephony system. The IP telephony system could then perform the remaining steps illustrated in FIG. 6.

In yet other alternate embodiments, once a quality monitoring unit 416 of a telephony device 400 has made a determination about the quality of a communication in step S602, the determination of whether the quality is below a threshold value, as performed in step S604, could also be performed by the quality monitoring unit 416 of the telephony device 400. If the quality is above the threshold value, steps S602, S604 and S606 would continue to be performed by the quality monitoring unit 416 as long as the quality remains above the threshold and the telephony communication is not terminated by their party.

If the quality monitoring unit 416 of the telephony device 400 determines that the quality has fallen below the threshold, in step S608, the cellular communication path set up unit 414 of the IP telephony client software 410 could cause a cellular based voice or video communications path to be established with the IP telephony system utilizing the wireless cellular transceiver 404 of the telephony device 400. Further, the communications path transition unit 420 of the IP telephony client software 410 could then transition the communication from the original IP based communications path to the cellular based voice or video communications path, as in step S610 of FIG. 6. Thus, all of the steps illustrated in FIG. 6 could be performed by elements of the telephony device 400.

In yet other embodiments, where the quality monitoring unit 416 of a telephony device 400 determines that the quality of a telephony communication has fallen below a threshold value, the IP telephony client software 410 of the telephony device 400 could then instruct the IP telephony system to set up the new cellular based voice or video communications path, and to then transition the communication from the IP based communications path to the cellular based communications path. Thus, steps S602, S604 and S606 could be performed by the telephony device 400, while steps S608 and S610 are performed by elements of the IP telephony system.

FIG. 7 illustrates a second method 700 which could be used to transition a call from an IP based communications path to a cellular based voice or video communications path in order to preserve call quality. In the method 700 illustrated in FIG. 7, however, rather than measuring a quality of the telephony communication, a strength of a wireless connection that a telephony device has established with either a wireless access point or an element of a cellular telephony system is determined, and the telephony communication is moved between communications paths if the strength of the wireless connection has fallen below a threshold.

The method 700 begins and proceeds to step S702 where a wireless connection monitoring unit 418 of a telephony device determines a signal strength of a wireless link which is being used to conduct an IP based communication. As explained above, the wireless link could be a wireless link between a wireless data transceiver 402 of the telephony device 400 and a wireless access point that provides access to a data network. Alternatively, the wireless link could be one established by the wireless cellular transceiver 404 to one or more elements of a cellular telephony system. In either case, the wireless link would be used to establish an IP based communications path between the telephony device 400 and an IP telephony system.

The method then proceeds to step S704 where a determination is made as to whether the strength of the wireless link is below a threshold. If not, meaning that the wireless link has sufficient strength, the method proceeds to step S706 where a delay period is allowed to expire. The method then proceeds to step S702 where another determination of the signal strength of the wireless link is made. Steps S702, S704 and S706 would continue to repeat so long as the signal strength is above the threshold, until one of the parties terminates the communication. The method would then end.

If the wireless link strength is determined to be below the threshold in step S704, the method proceeds to step S708. In step S708, a cellular based voice or video communications path is established between the IP telephony system and the telephony device. This can be accomplished by having an element of the telephony device 400 instruct the IP telephony system to create the cellular based voice or communications path. Alternatively, a cellular communications path setup unit 414 of the IP telephony client software 410 could cause the cellular based voice or video communications path to be established to the IP telephony system. This would likely involve placing an outgoing cellular telephone call to the IP telephony system using the wireless cellular transceiver 404.

In step S710, the communication is transitioned from the IP based communications path to the cellular based voice or video communications path. If the IP telephony system was responsible for setting up the new cellular based voice or video communications path, then the communications path transition unit 308 of the IP telephony system would likely handle the transition in step S710. Alternatively, if the cellular communication path set up unit 414 of the IP telephony client software 410 sets up the cellular based communications path, then the communications path transition unit 420 of the IP telephony client software 410 could handle the transition in step S710.

Although FIGS. 6 and 7 illustrate two different ways of determining when to transition a communication from an IP based communications path to a cellular based communications path, the determinations made in these two different methods could be combined into a single method. In other words, in some embodiments of the invention, both a determination the quality of the telephony communication and a determination the strength of a wireless link are made. If either the quality dips below a threshold or the signal strength of the wireless link dips below a threshold, the call can be transitioned from an IP based communications path to a cellular based voice or video communications path.

In addition, the methods illustrated in FIGS. 6 and 7 ended once the communication is transitioned to a cellular based voice or video communications path. In alternate embodiments, the original IP based communications path could be held open while the communication is ongoing. If the quality of the communication through the cellular based communications path begins to deteriorate, the methods could involve transitioning that leg of the communication back to the original IP based communications path.

Also, in the methods described above, if the quality of the call is above a threshold or the strength of the wireless link is above a threshold, a delay period is allowed to expire before a new quality or signal strength check is performed. In alternate embodiments of the invention, once an initial check has been performed, the method may involve waiting for a triggering event to occur before another check of the quality or signal strength is performed. The triggering event could be the expiration of a delay period, as illustrated in FIGS. 6 and 7. However, the triggering event could be other events, such as a transition from one cellular zone to another. Another triggering event could be the detection that the wireless link strength is gradually deteriorating, indicating that the telephony device is moving away from the element it is communicating with. Other triggering events could also cause a new check on call quality or wireless link strength.

In the embodiments illustrated in FIGS. 6 and 7, elements of the telephony device or the IP telephony system are used to determine when the quality of a communication has fallen below a threshold value. In alternate embodiments, a user of a telephony device involved in the communication could provide input, using their telephony device, to indicate that call quality has deteriorated. Upon receiving such input, either the IP telephony system or the telephony device could cause the communication to transition from an IP based communications path to a cellular based voice or video communications path using methods similar to those discussed above.

In still other embodiments of the invention, if a determination has been made that the quality of the communication has fallen below a threshold, or that the wireless link strength has fallen below a threshold, a party to the communication could be queried as to whether the communication should be transitioned from an IP based communications path to a cellular based communications path. For example, with reference to FIG. 5, if a determination is made that the quality of the first IP based communications path P1 has fallen below a threshold value, the first mobile telephony device 502 could present the user of that device with a query asking if the user would like the communication to be transitioned to a second cellular based communications path P2. If the user responds in a negative fashion, the call would continue using the first IP based communications path P1, despite the lowering of call quality. If the user responds affirmatively, than either the first mobile telephony device 502 or the IP telephony system 520 would cause the call to be transitioned to the second cellular based communications path P2. Obtaining the user's permission for the transition of the call to a cellular based communications path could be the desirable if making this change would involve applying increased or additional charges to the user's account. This is particularly true where it is necessary to establish a cellular based communications path to a telephony device located in a different country.

In many of the embodiments described above, a determination is made that the quality of an IP based communication path setup through a wireless access point has fallen below a threshold value. Alternatively, a software application on a telephony device that is seeking an alternate IP based communication path may check the wireless service offered by a wireless access point an find that it is insufficient, and thus never even try to setup a path through the wireless access point. When this type of information regarding a wireless access point is obtained by a telephony device, or a software application running on a telephony device, the information could be forwarded to the IP telephony system. The IP telephony system could then distribute this information to telephony device in the area, so that other telephony devices do not attempt to setup an IP based communication path using the deficient wireless access point.

In alternate embodiments of the invention, a software application on a user's telephony device may receive a new communication setup request for a communication that is to traverse an IP based communications path, and the software application may already be aware that the quality of any communication setup over the IP based communication path is likely to be poor. In this instance, the software application sends a message back to the IP telephony system requesting that the call be setup via a cellular based voice or video communication path. Thus, information about the likely quality of an IP based communication path that is known only to the software application on the user's telephony device could be used to setup the communication via a path having sufficient quality.

In still other embodiments, a software application on a user's telephony device may receive a request from the user to setup a new outgoing communication, and the software application may be aware that the communication likely will have poor quality if it is setup over an IP based communications path. In this instance, the software application will cause the outgoing communication to be setup via a cellular based communications path.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method, performed by one or more processors of an Internet Protocol (IP) telephony system, for transitioning a communications path of a telephony communication from an IP based communications path to a cellular based communications path, comprising:
determining whether a quality of a communication which is traversing an IP based communications path between a user's telephony device and an IP telephony system has fallen below a threshold;
causing a cellular based communications path to be setup between the IP telephony system and the user's telephony device if the determining step indicates that a quality of the communication has fallen below the threshold; and
transitioning media of the communication from the IP based communications path to the cellular based communications path.

2. The method of claim 1, wherein the determining step comprises detecting data packet delivery statistics for data packets bearing media of the communication and which are traversing the IP based communications path.

3. The method of claim 1, wherein the determining step comprises receiving a communication from the user's telephony device that is indicative of a quality of the communication which is traversing the IP based communications path.

4. The method of claim 1, wherein the determining step repeats upon occurrence of a triggering event while the communication is ongoing.

5. The method of claim 4, wherein the triggering event is the elapse of a predetermined period of time.

6. The method of claim 1, wherein the causing step comprises placing a call to the user's telephony device over a cellular telephony system.

7. The method of claim 6, wherein the call is sent from a gateway that is local to the user's telephony device.

8. The method of claim 1, wherein the causing step comprises causing the user's telephony device to place a call to the IP telephony system over a cellular telephony system.

9. The method of claim 1, further comprising the steps of:
inducing a message to be played or displayed to at least one party to the communication if the determining step indicates that a quality of the communication has fallen below the threshold; and
receiving input in response to the message that directs that the communication be switched to a cellular based communications path.

10. The method of claim 1, wherein the transitioning step comprises conferencing together the cellular based communications path and the IP based communication path.

11. The method of claim 10, further comprising terminating the IP based communications path after the cellular based communications path and the IP based communication path have been conferenced together.

12. A system for transitioning a communications path of a telephony communication from an IP based communications path to a cellular based communications path, comprising:
means for determining whether a quality of a communication which is traversing an IP based communications path between a user's telephony device and an IP telephony system has fallen below a threshold;
means for causing a cellular based communications path to be setup between the IP telephony system and the user's telephony device if the quality of the communication traversing the IP based communication path has fallen below the threshold; and
means for transitioning media of the communication from the IP based communications path to the cellular based communications path.

13. A system for transitioning a communications path of a telephony communication from an IP based communications path to a cellular based communications path, comprising:
a quality monitoring unit that determines whether a quality of a communication which is traversing an IP based communications path between a user's telephony device and an IP telephony system has fallen below a threshold;
a cellular communications path setup unit that causes a cellular based communications path to be setup between the IP telephony system and the user's telephony device if the quality of the communication traversing the IP based communications path has fallen below the threshold; and
a communications path transition unit that transitions media of the communication from the IP based communications path to the cellular based communications path.

14. The system of claim 13, wherein the quality monitoring unit detects data packet delivery statistics for data packets bearing media of the communication and which are traversing the IP based communications path.

15. The system of claim 13, wherein the quality monitoring unit receives a communication from the user's telephony device that is indicative of a quality of the communication which is traversing the IP based communications path.

16. The system of claim 13, wherein the quality monitoring means determines whether a quality of a communication which is traversing an IP based communications path between a user's telephony device and an IP telephony system has fallen below a threshold each time that a triggering event occurs while the communication is ongoing.

17. The system of claim 16, wherein the triggering event is the elapse of a predetermined period of time.

18. The system of claim 13, wherein the cellular communications path setup unit causes a call to be placed to the user's telephony device over a cellular telephony system.

19. The system of claim 18, wherein the cellular communications path setup unit causes the call is sent from a gateway that is local to the user's telephony device.

20. The system of claim 13, wherein the cellular communications path setup unit causes the user's telephony device to place a call to the IP telephony system over a cellular telephony system.

21. The system of claim 13, wherein the cellular communications path setup unit induces a message to be played or displayed to at least one party to the communication if the quality monitoring unit determines that a quality of the communication has fallen below the threshold, and wherein the cellular communications setup unit receives input in response to the message that directs that the communication be switched to a cellular based communications path.

22. The system of claim 13, wherein the communications path transition unit conferences together the cellular based communications path and the IP based communication path.

23. The system of claim 22, wherein the communications path transition unit terminates the IP based communications path after the cellular based communications path and the IP based communication path have been conferenced together.
